(19) United States
(12) Patent Application Publication
(10) Pub. No.: US 2007/0103463 A1
(43) Pub. Date: May 10, 2007

(54) Simulation apparatus

(76) Inventors: Fumiko Beniyama, Yokohama (JP); Toshio Moriya, Tokyo (JP); Hitoshi Namai, Hitachinaka (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/512,252

(22) Filed: Aug. 30, 2006

(30) Foreign Application Priority Data
Aug. 31, 2005 (JP) 2005-252008

(51) Int. Cl. G06T 15/40

(52) U.S. Cl. 345/422

(57) ABSTRACT

To realize high speed simulation a simulation apparatus is provided with a graphics board including a depth buffer that stores a depth value of each polygon represented by three dimensional polygon data. In the graphics board, the depth value of each polygon is calculated on the basis of a camera parameter and the three dimensional polygon data, and the depth value within the depth buffer is sequentially updated with the calculated depth value. According to the depth value, sensor data is generated and outputted.

### BACKGROUND OF THE INVENTION

The present invention relates to a driving support system which supports autonomous driving of a moving object, such as a mobile robot or a vehicle, and in particular, it relates to a sensor simulation apparatus that utilizes hardware.

In controlling autonomous driving of a moving object, such as a driving mobile robot or an automotive vehicle, it is necessary to recognize a positional relationship between the moving object and an obstacle in the vicinity, a wall face, and the like. Therefore, the moving object is equipped, as appropriate, with various sensors including a visual sensor such as a camera, a laser sensor to measure distance between the moving object and the nearby obstacle, an infrared laser, and the like. According to analysis of sensing data from those sensors, it is possible to perceive a three-dimensional environment on an unknown path, for instance.

In an experiment using an actual machine, verification of operations cannot be conducted easily, because time is required for setting up, and the like. Therefore, in general, a simulation is performed in advance, and according to a result of the simulation, a position, angle, and the like, of the obstacle is studied. For example, as a technique relating to such a kind of simulation, an art as described in the Japanese Patent Laid-Open Publication No. 2003-15739 (hereinafter, referred to as “Patent Document 1”) is well known. With this technique, it is possible to improve positional resolution in an area in proximity to the moving object and to enhance speed of simulation, when the moving object that is autonomously driving performs a self-localization process and a guidance control process.

### SUMMARY OF THE INVENTION

In the above conventional art, processing speed is enhanced by using a software algorithm. However, there is a restriction in enhancement of the simulation speed by the software algorithm.

In view of the above problem, an object of the present invention is to provide a simulation apparatus which is capable of executing simulation at higher speeds.

The present invention enhances the speed of simulation by using general-purpose hardware. Specifically, the present invention provides a simulation apparatus that includes, a camera parameter generating means that generates a camera parameter for a three-dimensional computer graphic, on the basis of sensor specification information regarding measurement by a sensor, and a sensor position and posture parameter indicating a position and posture of the sensor, a graphics board having a depth buffer that stores depth value of each polygon represented by three-dimensional polygon data, and calculating the depth value of each polygon on the basis of the camera parameter, the three-dimensional polygon data, and an error model, and updates the depth value within the depth buffer sequentially with the calculated depth value, and a sensor data output means that converts the depth value into sensor data and outputs the converted data.

### BRIEF DESCRIPTION OF THE DRAWINGS

FIG. 1 is a diagram showing a schematic configuration of a simulation system relating to one embodiment of the present invention;

FIG. 2 is a block diagram showing the simulation system relating to the first embodiment of the present invention;

FIG. 3 is a flowchart of processing executed in the simulation system relating to the first embodiment of the present invention

FIG. 4 is a diagram showing a data structure of sensor specification information;

FIG. 5 is a diagram showing a data structure of a sensor position and posture parameter;

FIG. 6 is a diagram showing data that is included in error model data;

FIG. 7 is an illustration showing an interface used for inputting data;

FIG. 8 is a diagram showing a data structure of a camera parameter;

FIG. 9 is a diagram showing a data structure of sensor data;

FIG. 10 is a schematic diagram of the simulation system relating to the second embodiment of the present invention;

FIG. 11 is a block diagram showing the simulation system relating to the second embodiment of the present invention; and

FIG. 12 is a flowchart showing the processing executed in the simulation system relating to the second embodiment of the present invention.

### DETAILED DESCRIPTION OF THE PREFERRED EMBODIMENTS

A preferred embodiment of the present invention will be explained with reference to the accompanying drawings.

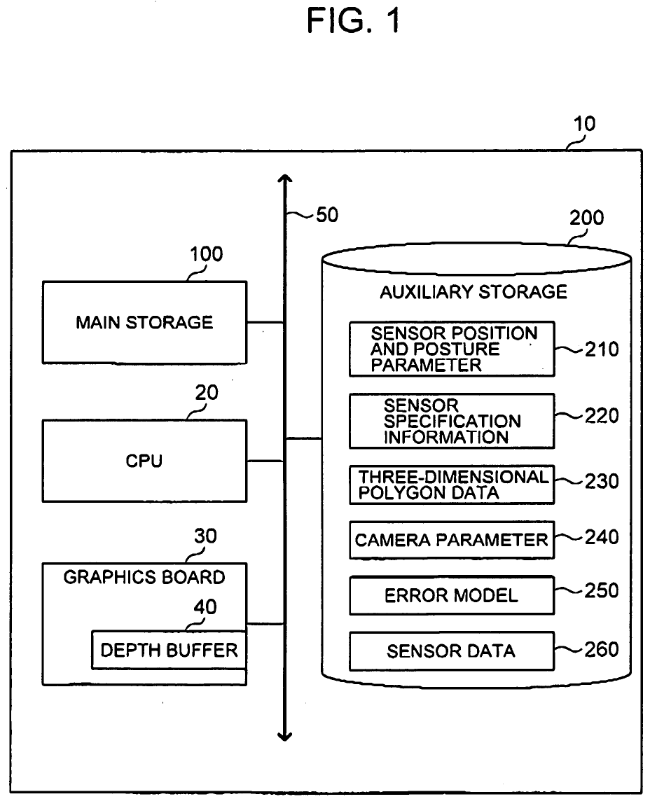

Firstly, with reference to FIG. 1, a configuration of the simulation system relating to the present embodiment will be explained.

The simulation system 10 according to the present embodiment includes, (1) main storage 100 such as a memory, (2) auxiliary storage 200 such as hard disk in which a program to implement the after-mentioned simulation processing is installed, and various data is also stored therein, (3) CPU 20 that executes the program loaded onto the main storage 100 from the auxiliary storage 200, (4) a graphics board 30 on which a dedicated circuit that performs high-speed execution of three-dimensional graphics processing, a memory to hold image data, and a depth buffer 40 that stores, for each pixel, distance data from a viewpoint, and (5) a bus 50 that connects the elements above with one another.

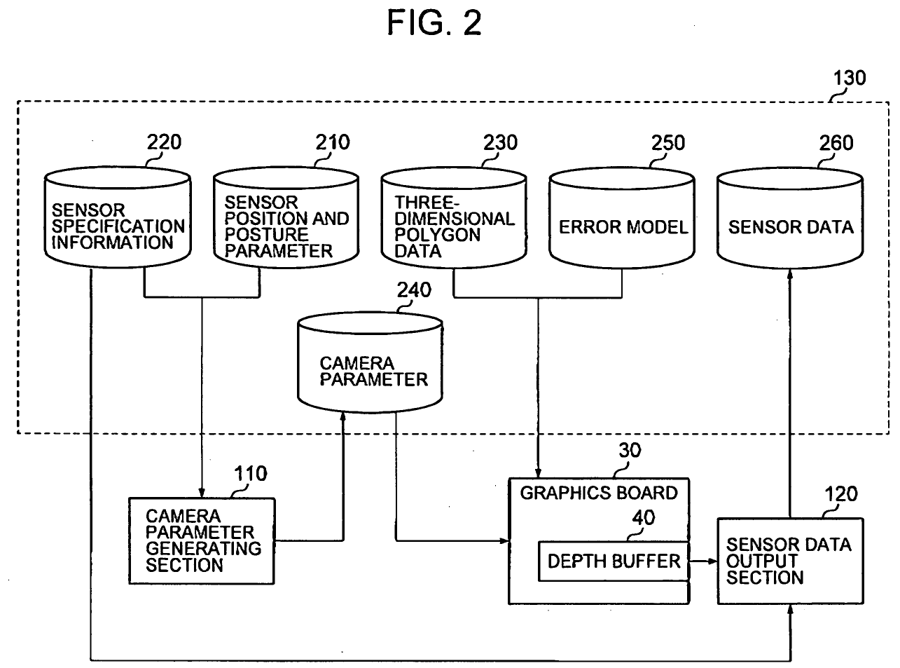

In a hardware structure as described above, execution of the program loaded in the main storage 100 implements a configuration that provides the graphic board 30 with inputted data. Specifically, as shown in FIG. 2, camera parameter generating section 110 and sensor data output section 120 are implemented. Here, the camera parameter generating section 110 calculates camera parameter 240 on the basis of sensor position and posture parameter 210 and sensor specification information 220, and the sensor data output section 120 outputs sensor data 260 on the basis of distance data within the depth buffer and the sensor specification information 220.

With the configuration as described above, the sensor position and posture parameter 210 and the sensor specification information 220 are converted into the camera parameter 240, and further, the graphics board 30 generates a distance image representing a distance from the camera, on the basis of this camera parameter 240 and the three-dimensional polygon data 230. Here, a depth value with respect to each polygon of the three-dimensional polygon data 230 is calculated. In the present embodiment, the depth buffer 40 within the graphics board 30 performs near-or-far determination, and sequentially updates and stores a value that is closer to a viewpoint position in each pixel. In other words, the hardware directly performs the above processing, thereby reducing calculation time. Then the sensor data output section 120 calculates distance data at each angle on the basis of the depth value accumulated in the depth buffer 40, and an angle resolution and view angle included in the sensor specification information 220, and outputs the calculated result as sensor data 260.

Next, data stored in the auxiliary storage 200 will be explained.

The auxiliary storage 200 further stores input data used in the simulation processing, camera parameter 240 obtained by the simulation, sensor data (distance data from the sensor at each angle) 260 as a result of the simulation, and three-dimensional polygon data 230 that is a target for sensing.

The input data includes a sensor position and posture parameter 210, sensor specification information 220, and an error model 250.

The sensor position and posture parameter includes data that is obtained by time-based recording of the position and posture of a sensor mounted on a moving object such as an automotive vehicle or a robot. Specifically, as shown in FIG. 5, the sensor position and posture parameter includes frame number, positional coordinates (X, Y, Z) of the sensor on the XYZ coordination system, and a directional vector of the sensor, with respect to each frame. It is to be noted that if sensing is performed while tilt of the sensor is changed, it is preferable to add data that represents the tilt of the sensor.

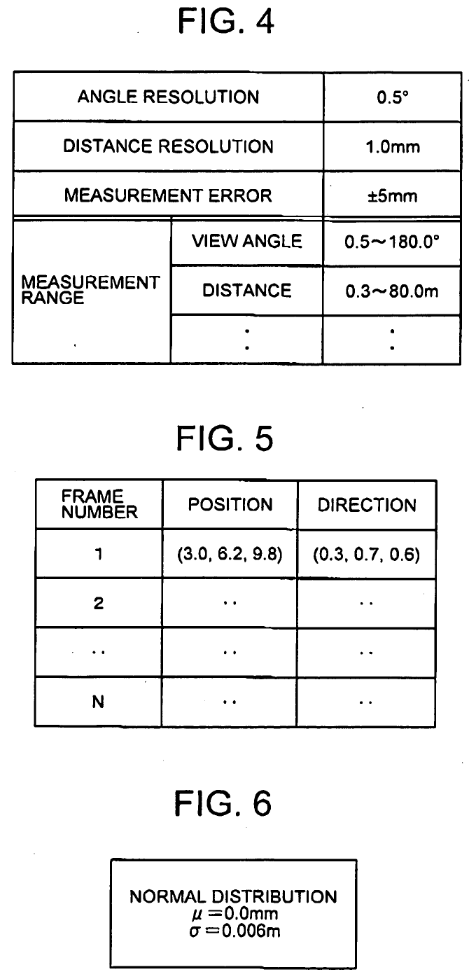

The sensor specification information includes data representing the specification of the sensor. FIG. 4 shows an example of the sensor specification information of a laser sensor that obtains dispersive data per predetermined angle while scanning a target for sensing, so that linear data is ultimately obtained. The sensor specification information of the laser sensor as described above includes an angle resolution representing an angular space to obtain distance data, a distance resolution representing resolution of the distance data, measurement error range information representing accuracy of the distance measurement, and measurement range information indicating a range measurable by the sensor. The measurement range information includes measurable view angle (horizontal view angle only in cases of obtaining linear data), a range of distance measurable by the sensor, and the like. It is to be noted that the sensor specification information relating to other laser sensors such as a sensor for obtaining point data and a sensor for obtaining plane data, which are different in sensing method, may include data complying with the data to be obtained.

Error model data includes data representing estimated error when the simulation is performed. For example, if it is assumed that the error at the time of the simulation follows a normal distribution, it is possible to employ as the error model data, a value thus distributed and the standard deviation as shown in FIG. 6. This error model data is utilized when distance data is generated, so that a measured error included in an actual value obtained in the measurement using an actual machine may be taken into account. In other words, the distance data is calculated on the basis of the three-dimensional polygon data 230, the camera parameter 240, and the error model 250, so that the distance data approaches the actual value.

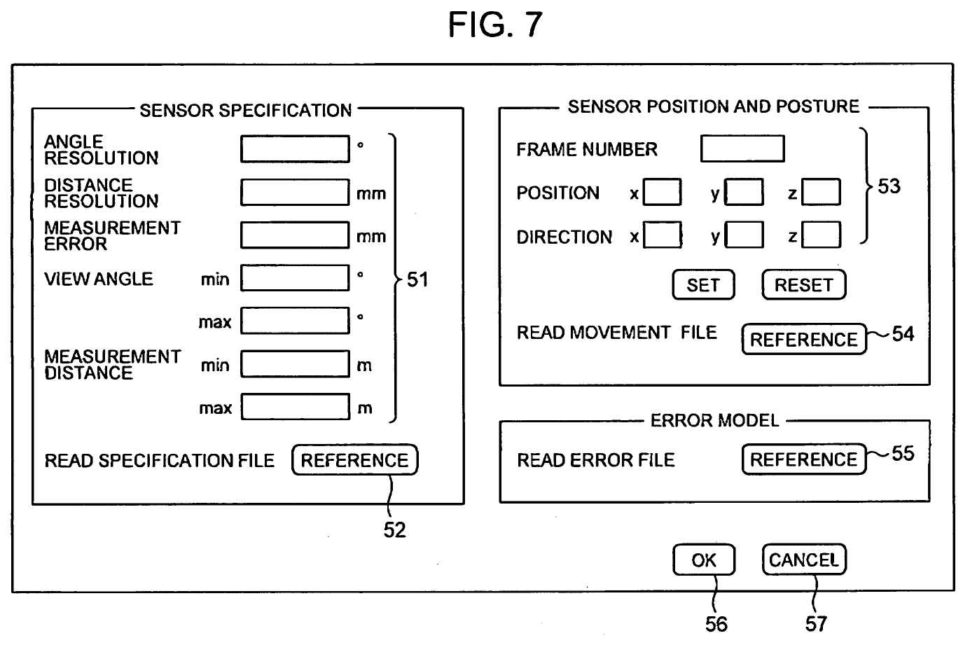

These input data items may be read from a data file in which data is described according to a predetermined format, or they may be manually inputted from an input device. If a display device is provided on the simulation system, a screen as shown in FIG. 7, for example, may be displayed so as to support inputting of those input data items.

Arranged on this screen are input fields 51 that accept input of each item of data included in the sensor specification information, a reference button 52 that accepts an instruction to read the sensor specification information from the specification file, input fields 53 that accept input of each item of data included in the sensor position and posture parameter, a reference button 54 that accepts an instruction to read the sensor position and posture parameter from an operation file, reference button 55 that accepts an instruction to read the error model data from the error file, an OK button 56 that accepts a registration instruction as to settings on this screen, and a cancel button 57 that accepts an instruction to cancel the settings on the screen.

By the use of this screen, the user is allowed to directly input the sensor specification information and the sensor position and posture parameter manually, or those data items may be read out from designated files. It is to be noted that since the amount of data of the sensor position and posture parameter is normally large, it is desirable to input data items of key frames into the input fields 53, and then to interpolate those data items.

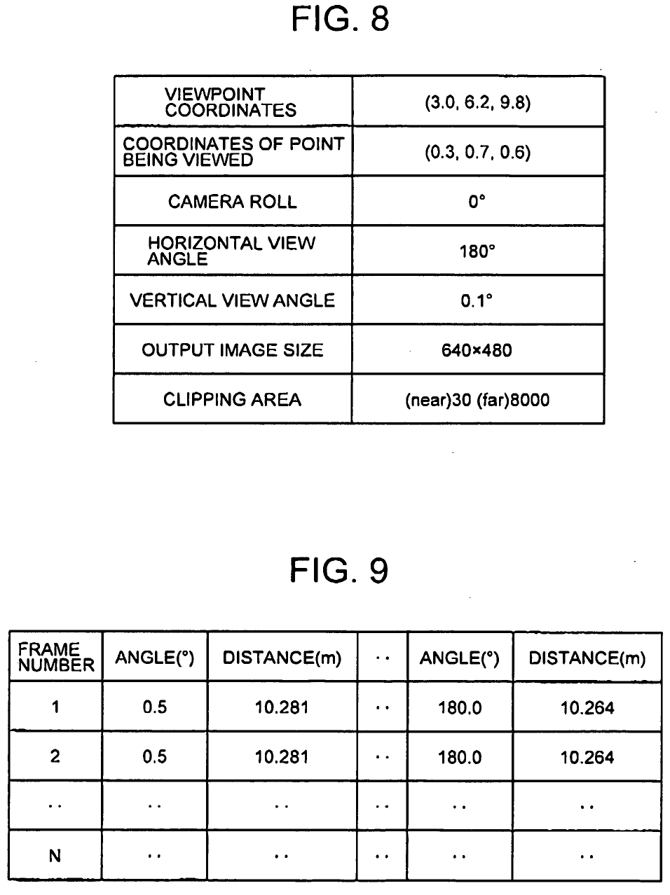

The camera parameter includes camera-related data that is required to perform simulation utilizing a rendering function of a three-dimensional computer graphic. For example, as shown in FIG. 8, such data includes viewpoint coordinates indicating the position of the camera, coordinates of point being viewed that indicate the camera orientation, camera roll per frame (animation data), horizontal view angle, vertical view angle, output image size determining a size of an area to be reserved in the depth buffer, and clipping area range.

As shown in FIG. 9, the sensor data includes distance data calculated per angle indicated by the angle resolution, within the range of the view angle, with respect to each frame. Specifically, there is stored a list of correspondence information established among a frame number, degrees of view starting from zero degrees, and distance data, with respect to each frame.

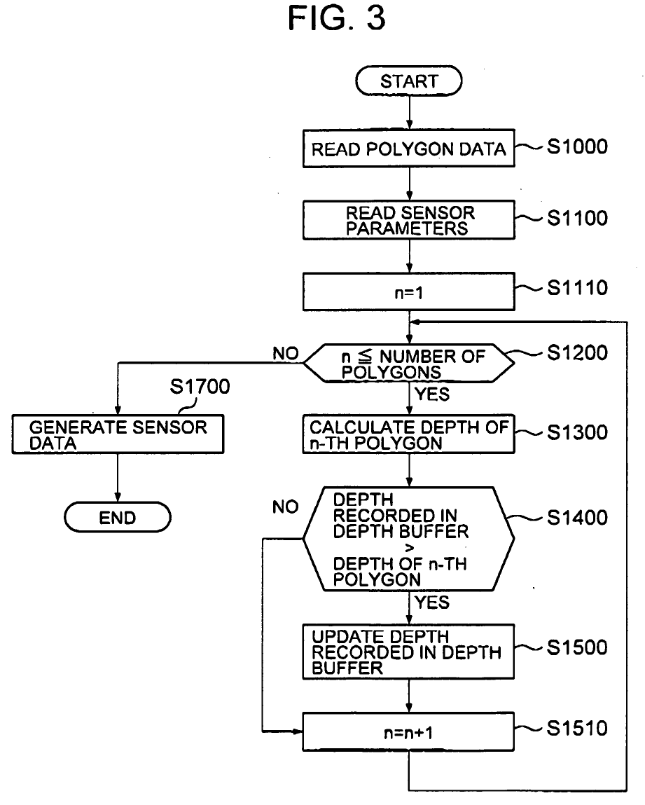

Next, with reference to FIG. 3, processing executed by the configuration as shown in FIG. 2 will be explained. Hereinafter, a main executing element that performs the processing in the graphics board 30 is referred to simply as the graphics board 30.

Firstly, the graphics board 30 reads the three-dimensional polygon data 230, as a sensing target, and the error model 250 from the auxiliary storage (S1000), and also reads sensor parameters (optical center, optical axis, and sensing area) in the initial state of the sensor (S1100) In addition, the graphics board 30 sets 1 as a parameter n (S1110).

Afterwards, the graphics board 30 executes the following processing for each polygon.

The graphics board 30 compares the value of the parameter n and the number of polygons (S1200).

As a result of the comparison, if the value of the parameter n is larger than the number of polygons, the sensor data output section 120 generates sensor data according to the output from the graphics board 30 (S1700).

On the other hand, if the value of the parameter n is equal to or less than the number of polygons, the graphics board 30 calculates a depth value of the n-th polygon (S1300).

The graphics board 30 compares the depth value recorded in the depth buffer and the depth value of the n-th polygon, with regard to a corresponding pixel when the polygon is projected on a perspective projection plane with the depth value (S1400). Consequently, only when the depth value of the n-th polygon is smaller than the depth value in the depth buffer, the depth value of the corresponding pixel within the depth buffer is updated (S1500).

Subsequently, the graphics board 30 increments the value of n by 1, in order to execute the same processing for the next polygon (S1510). Then, the processing from S1200 is executed again.

In the processing as described so far, the sensor data is generated by simulation. However, it is also possible to generate a display image that allows numerical values of the sensor data to be visually recognized, together with generating the sensor data. Hereinafter, an explanation will be made for cases where such a procedure is followed.

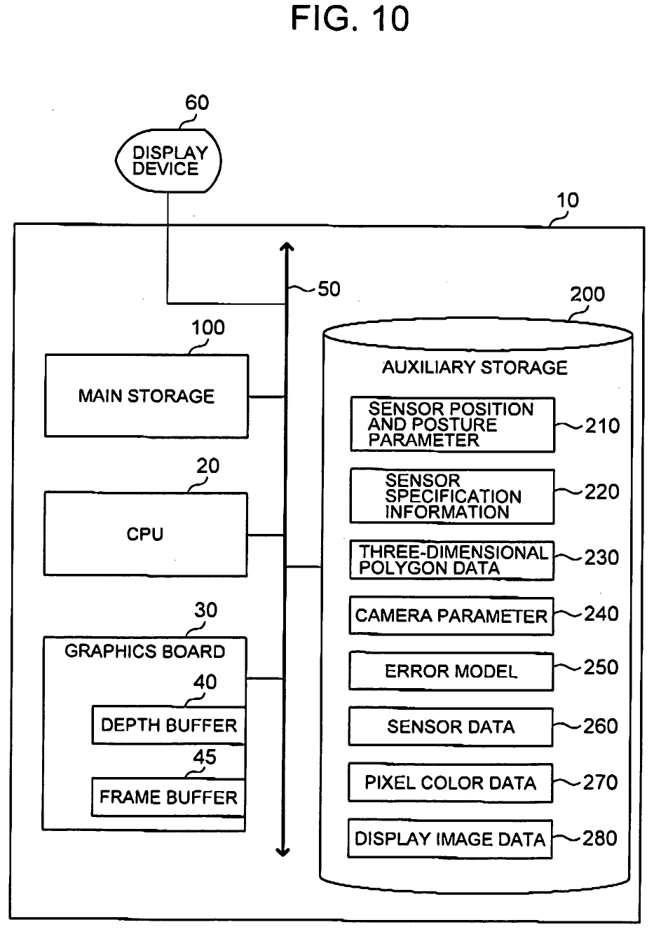

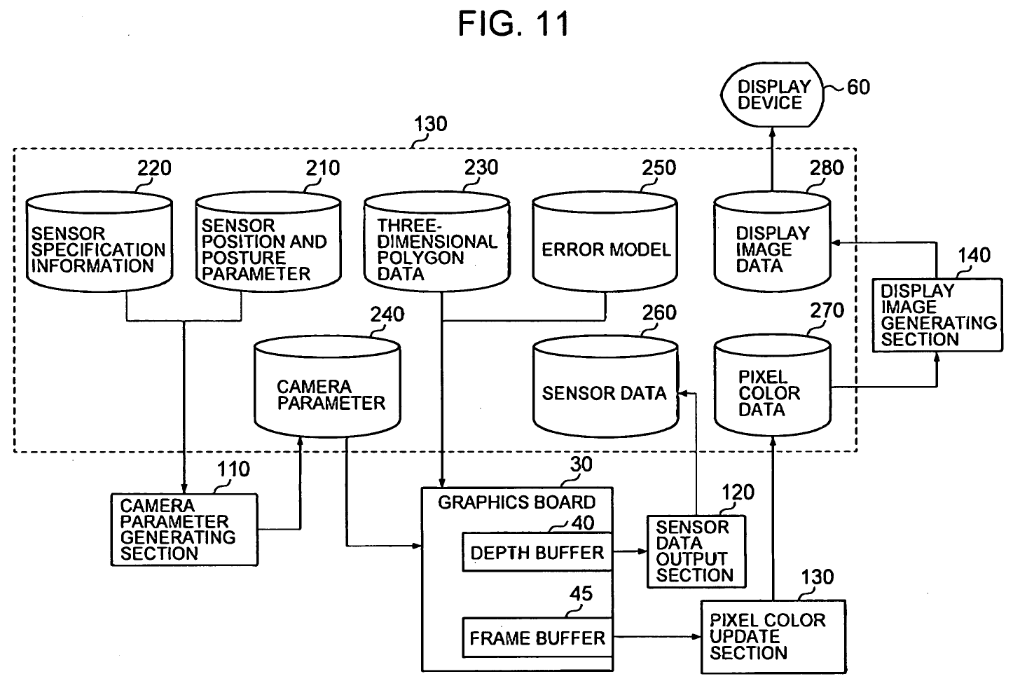

FIG. 10 shows a hardware configuration of a simulation system that generates a display image together with generating the sensor data, and FIG. 11 shows a configuration that is implemented by this simulation system.

In addition to the configuration as shown in FIG. 1, the simulation system according to the present example is provided with a frame buffer 45 mounted on the graphics board 30, and a display device 60 to display the output image. Then, the auxiliary storage 200 stores, in addition to the aforementioned data, color data as to each pixel (pixel color data 270), and a display image data 280 that has been generated together with the sensor data.

In addition to the configuration as shown in FIG. 2, the simulation system according to the present example further implements a pixel color update section 130 that updates a pixel color according to the degree of the depth value in each pixel, and a display image generating section 140 that generates a display image 280 that allows the numerical values of the sensor data to be visually recognized.

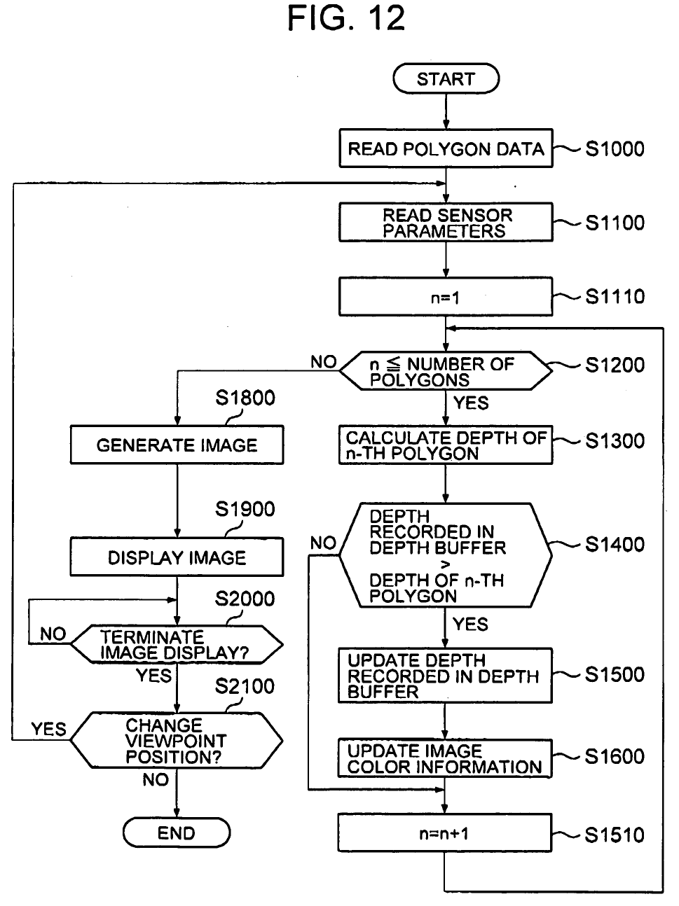

FIG. 12 shows a flowchart of the processing that is executed in this simulation system.

In this processing, unlike the aforementioned case, if the value of the parameter n is larger than the number of polygons as a result of the comparison process in S1200, the display image generating section 140 generates an image according to the color information of each pixel (S1800), and displays the image on the display device 60 (S1900). Here, in receipt of an instruction to terminate displaying the image (S2000), the display image generating section 140 determines whether or not this instruction is caused by a positional change of viewpoint (S2100).

Consequently, if the instruction to terminate displaying the image is caused by the positional change of viewpoint, the sensor parameters are updated, and processing from S1100 is executed again.

On the other hand, if the instruction to terminate displaying the image is not caused by the positional change of viewpoint (here, it corresponds to termination of simulation), it is assumed that the entire processing is completed, and the simulation comes to end.

In the case above, since a polygon having the lowest depth value (i.e., a polygon on the front-end surface) is displayed on a priority basis, the depth buffer 40 stores the minimum depth value, and in S1400, the graphics board 30 determines whether or not the depth value of the n-th polygon is smaller than the minimum depth value.

As a result, when it is determined that the depth value of the n-th polygon is smaller, the graphics board 30 replaces the depth value in the depth buffer with the depth value of the n-th polygon. Simultaneously, the graphics board 30 stores the color information of the n-th polygon in the frame buffer 45 (S1500). Accordingly, the depth value in the depth buffer 40 is updated with the smaller depth value of the polygon, and every time when the depth value in the depth buffer 40 is updated, the color information of the polygon having a smaller depth value is stored in the frame buffer 45.

In addition, when the color information of the polygon having the smaller depth value is stored in the frame buffer 45, the pixel color update section 130 extracts the color information from the frame buffer, and updates the pixel color data 270 of the corresponding pixel with this color information (S1600).

On the other hand, in S1400, if it is determined that the depth value of the n-th polygon is equal to or larger than the minimum depth value that is recorded in the depth buffer, the graphics board 30 does not update the depth buffer nor update the pixel color data.

Subsequently, similar, to the case as described above, the graphics board 30 increments the value of n by 1, in order to execute the same processing as to the next polygon (S1510), and executes the processing from S1200 again.

With the processing as described above, it is possible to display a display image that allows numerical values of the sensor data to be visually recognized.

The present invention is applicable to a system that utilizes a distance sensor, such as a three-dimensional measuring system to measure an unknown object, and an autonomous drive system of a moving object (an automotive vehicle or a robot).

What is claimed is:

1. A simulation apparatus comprising:
a camera parameter generating means that generates a camera parameter for a three-dimensional computer graphic, on the basis of sensor specification information regarding measurement by a sensor, and a sensor position and posture parameter indicating a position and posture of the sensor;
a graphics board having a depth buffer that stores a depth value of every polygon represented by three-dimensional polygon data, calculating the depth value of each polygon on the basis of the camera parameter and the three-dimensional polygon data, and sequentially updating the depth value within the depth buffer with the calculated depth value; and
a sensor data output means that converts the depth value into sensor data and outputs the converted data.

2. A simulation apparatus according to claim 1, wherein,
the graphics board calculates the depth value of each polygon, based on the camera parameter, an error model representing a measurement error of the sensor, and the three-dimensional polygon data.

3. A simulation apparatus according to claim 1, wherein
the graphics board further comprises a frame buffer, and
the simulation apparatus comprises a pixel color updating means that generates a display image in which a color of a corresponding polygon is made a pixel color, when the depth value that was calculated is smaller than the depth value within the depth buffer.
